(19) United States
(12) Patent Application Publication
(10) Pub. No.: US 2017/0262129 A1
(43) Pub. Date: Sep. 14, 2017

(54) ELECTRICAL DEVICE

(71) Applicant: Industrial Technology Research Institute, Hsinchu (TW)

(72) Inventors: Wei-Yuan Cheng, Hsinchu County (TW); Chih-Chia Chang, Hsinchu County (TW); Ruo-Lan Chang, New Taipei City (TW); Pei-Pei Cheng, Taoyuan City (TW); Chao-Wen Chen, Miaoli County (TW)

(73) Assignee: Industrial Technology Research Institute, Hsinchu (TW)

(21) Appl. No.: 15/235,126

(22) Filed: Aug. 12, 2016

(30) Foreign Application Priority Data
Mar. 14, 2016 (TW) 105107718

(51) Int. Cl. G06F 3/041; G06F 3/044

(52) U.S. Cl. CPC G06F 3/0418; G06F 3/0414; G06F 3/044; G06F 3/0412; G06F 2203/04107; G06F 2203/04105

(57) ABSTRACT

According to an embodiment of the present disclosure, an electrical device may include a substrate, an electrical element, a first barrier structure and a gas barrier layer. The substrate includes an active region and a periphery region surrounding the active region. The electrical element is disposed in the active region. The first barrier structure is disposed in the periphery region and surrounds the electrical element, wherein the first barrier structure includes a first conductive layer. The gas barrier layer covers the electrical element and the first barrier structure.

### CROSS-REFERENCE TO RELATED APPLICATION

This application claims the priority benefit of Taiwan application serial no. 105107718, filed on Mar. 14, 2016. The entirety of the above-mentioned patent application is hereby incorporated by reference herein and made a part of this specification.

### TECHNICAL FIELD

The present disclosure relates to an electrical device.

### BACKGROUND

In general, an electrical device such as a sensing device or an environmental sensitive device is susceptible to interference from external signals, thereby reducing the sensing ability and/or electrical characteristics of the electrical device. Take a touch display panel as an example, the drive circuits of the display panel and the touch panel may be designed separately and operate independently. The touch panel may be built into or attached to the outside of the display panel, the output sensing signals of the touch panel may be affected by the electrical field of the display panel, which will affect the touch quality of the touch panel (for example, sensitivity or accuracy).

Similarly, when an element such as an organic light-emitting diode and a functional film such as a touch panel are packaged together, the element may be affected by the electrical field of the functional film, which will affect the electrical characteristics of the element.

### SUMMARY

In an embodiment of the present disclosure, an electrical device may include a substrate, an electrical element, a first barrier structure and a gas barrier layer. The substrate includes an active region and a periphery region surrounding the active region. The electrical element is disposed in the active region. The first barrier structure is disposed in the periphery region and surrounds the electrical element, wherein the first barrier structure includes a first conductive layer. The gas barrier layer covers the electrical element and the first barrier structure.

The foregoing will become better understood from a careful reading of a detailed description provided herein below with appropriate reference to the accompanying drawings.

### BRIEF DESCRIPTION OF THE DRAWINGS

FIG. 1A is a schematic top view of an electrical device according to an embodiment of the present disclosure.

FIG. 1B is a partial schematic cross-sectional view of FIG. 1A along line I-I′.

FIG. 2A is a schematic top view of an electrical device according to an embodiment of the present disclosure.

FIG. 2B is a partial schematic cross-sectional view of FIG. 2A along line I-I′.

FIG. 3A to FIG. 3C are partial schematic cross-sectional views according to several embodiments of a first barrier structure, respectively.

FIG. 4A is a schematic view of a first barrier structure and a second barrier structure according to an embodiment of the present disclosure.

FIG. 4B is a partial schematic cross-sectional view of FIG. 4A along line I-I′.

FIG. 5 is a schematic view of a first barrier structure and a second barrier structure.

FIG. 6 is a schematic view of a first barrier structure and a second barrier structure.

FIG. 7A is a schematic view of a first barrier structure and a second barrier structure according to an embodiment of the present disclosure.

FIG. 7B is a partial schematic cross-sectional view of FIG. 7A along line I-I′.

FIG. 8 is a schematic view of a first barrier structure and a second barrier structure.

FIG. 9A is a schematic view of a first barrier structure and a second barrier structure according to an embodiment of the present disclosure.

FIG. 9B is a partial schematic cross-sectional view of FIG. 9A along line I-I′.

FIG. 10 is a schematic view of a first barrier structure and a second barrier structure.

FIG. 11A is a schematic view of a first barrier structure and a second barrier structure according to an embodiment of the present disclosure.

FIG. 11B is a partial schematic cross-sectional view of FIG. 11A along line I-I′.

FIG. 12A is a schematic view of a first barrier structure and a second barrier structure according to an embodiment of the present disclosure.

FIG. 12B is a partial schematic cross-sectional view of FIG. 12A along line I-I′.

FIG. 13 is a partial schematic cross-sectional view of a first barrier structure and a second barrier structure.

FIG. 14 is a partial schematic cross-sectional view of a first barrier structure and a second barrier structure.

FIG. 15 is a partial schematic cross-sectional view of a first barrier structure and a second barrier structure.

FIG. 16 is a partial schematic cross-sectional view of a first barrier structure and a second barrier structure.

FIG. 17 is a partial schematic cross-sectional view of a first barrier structure and a second barrier structure.

FIG. 18 is a partial schematic cross-sectional view of a first barrier structure and a second barrier structure.

FIG. 19 is a partial schematic cross-sectional view of a first barrier structure and a second barrier structure.

FIG. 20 is a schematic top view of a first barrier structure and a second barrier structure.

FIG. 21 is a schematic top view of a first barrier structure and a second barrier structure.

### DETAILED DESCRIPTION

Below, exemplary embodiments will be described in detail with reference to accompanying drawings to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

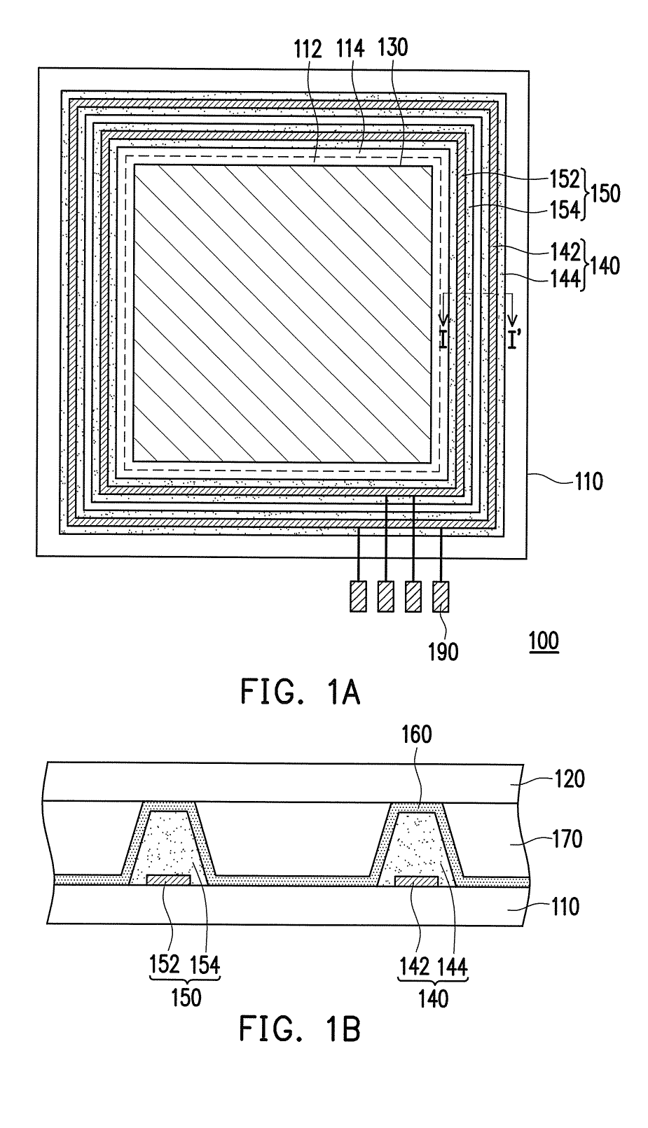

FIG. 1A is a schematic top view of an electrical device according to an embodiment of the present disclosure. FIG. 1B is a partial schematic cross-sectional view of FIG. 1A along line I-I′. Referring to FIG. 1A and FIG. 1B, in the embodiment, a electrical device 10 may include a first substrate 110, a second substrate 120, an electrical element 130, a first barrier structure 140 and a gas barrier layer 160. The first substrate 110 includes an active region 112 and a periphery region 114 surrounding the active region 112. The second substrate 120 may be disposed on the first substrate 110. The electrical element 130 may be disposed in the active region 112 of the first substrate 110 and located between the first substrate 110 and the second substrate 120. The first barrier structure 140 may be disposed in the periphery region 114 and surround the electrical element 130, wherein the first barrier structure 140 may include a first conductive layer 142, and a total resistance of the first barrier structure 140 is small than 10KΩ. The gas barrier layer 160 may cover the electrical element 130 and the first barrier structure 140. In the embodiment, the electrical device 100 may further include at least one second barrier structure 150. The first barrier structure 140 and the second barrier structure 150 may be disposed in the periphery region 114 of the first substrate 110 and located between the first substrate 110 and the second substrate 120. The first barrier structure 140 and the second barrier structure 150 surround the electrical element 130 respectively, and the at least one second barrier structure 150 is located between the first barrier structure 140 and the electrical element 130. The gas barrier layer 160 may cover the first barrier structure 140 and the second barrier structure 150.

In the embodiment, the first substrate 110 and the second substrate 120 are flexible substrates, for example, and a material of the flexible substrates may be glass, polyethylene terephthalate (PET), polyethylene naphthalate (PEN), polyethersulfone (PES), polymethyl methacrylate (PMMA), polycarbonate (PC), polyimide (PI), or metal foil, etc.

In an embodiment, the electrical element 130 is a sensing array, for example. In general, the electrical element 130 may be a touch panel, for instance, the touch panel may refer to a surface-capacitive touch panel, a digital matrix touch panel (such as projected capacitive touch panel) or an analog matrix touch panel. In brief, the electrical device 100 in one embodiment of the present disclosure may be capable of performing the touch function. In an embodiment, the electrical element 130 is an active element or a passive element, for example. The active element may be such as an active matrix organic light-emitting diode (AM-OLED), an active matrix electro-phoretic display (AM-EPD) known as e-paper, an active matrix liquid crystal display (AM-LCD), or an active matrix blue phase liquid crystal display, etc. The passive element may be such as a passive matrix OLED (PM-OLED) or a super twisted nematic liquid crystal display (STN-LCD), etc. In the embodiment, the electrical device 100 may further include an encapsulation layer 170. The encapsulation layer 170 may be located between the first substrate 110 and the second substrate 120 and encapsulate the electrical element 130 and the gas barrier layer 160. In the embodiment, the encapsulation layer 170 is formed by ultraviolet (UV) curing or thermal curing an adhesive material, for example. The adhesive material may be, for instance, made of acrylic resin or epoxy resin. In the embodiment, a type of the encapsulation layer 170 may be, for instance, pressure-sensitive type adhesive material, fill type material, or contain some air. In one embodiment, the encapsulation layer 170 may be disposed between the second substrate 120 and the gas barrier layer 160.

In an embodiment, a total resistance of the second barrier structure 150 may be different from that of the first barrier structure 140. In an embodiment, the total resistance of the first barrier structure 140 is less than 10KΩ, for example. The first barrier structure 140 includes an inner side adjacent to the electrical element 130 and an outer side opposite to the inner side. A shielding effect of the first barrier structure 140 may be such that a signal to noise ratio is greater than 1.5:1 in the inner side. That is, the first barrier structure 140 may shield external signal to prevent the electrical element 130 located in the inner side of the first barrier structure 140 from being interfered. In the embodiment, the first barrier structure 140 may be located together with the second barrier structure 150 on the first substrate 110 or the second substrate 120, wherein the second barrier structure 150 is located in the periphery region 114 and located between the electrical element 130 and the first barrier structure 140. The exemplary embodiment shown in FIG. 1A illustrates one second barrier structure 150 included in the electrical device 100. The electrical device 100 may include a plurality of second barrier structures 150 in other embodiments, and the plurality of second barrier structures 150 may be located between the electrical element 130 and the first barrier structure 140. In other words, the first barrier structure 140 is the outermost barrier structure. Further, the first barrier structure 140 and the second barrier structure 150 may be located on the first substrate 110 or the second substrate 120, respectively.

The first barrier structure 140 and the second barrier structure 150 extend toward the second substrate 120, for example, wherein a shape of a cross-section of the first barrier structure 140 perpendicular to the first substrate 110 may be, for instance, a trapezoidal shape. On the other hand, a shape of a cross-section of the second barrier structure 150 perpendicular to the first substrate 110 may be, for instance, a trapezoidal shape. In other embodiments, the foregoing shape of the cross-section may be a rectangular shape, a polygonal shape, a bullet-shape, a circular shape, or an elliptical shape, but the present disclosure is not limited thereto.

Referring to FIG. 1B, the first barrier structure 140 may include a first conductive layer 142. For instance, a resistance of the first conductive layer 142 is less than 10KΩ. A material of the first conductive layer 142 may include a metal material or other suitable material, and the metal material such as Cu, Ag, Al, Mo, Ti, Ni, W, Zn, Cr, Ta, Sn, Fe, Pt, Ru, Pd, Re, Rh, Au, or combination thereof, but the present disclosure is not limited thereto. Forming the first conductive layer 142 on the first substrate 110 may be by such as etching, photolithography, printing, or the like, for example. In the embodiment, the first barrier structure 140 may further include a first barrier layer 144, and the first conductive layer 142 may be located between the first barrier layer 144 and the first substrate 110. Generally, a material of the first barrier layer 144 may include an inorganic material or an organic-inorganic hybrid material. Forming the first barrier layer 144 on the first substrate 110 may be by such as etching, printing, photolithography, or the like, and the first barrier layer 144 may cover the first conductive layer 142. On the other hand, a material of the gas barrier layer 160 may include an inorganic material, and the inorganic material may be such as silicon oxide, silicon nitride, silicon oxynitride, aluminum oxide, etc. Forming the gas barrier layer 160 on the first barrier layer 144 may be by such as coating, evaporation, sputtering, or the like.

In the embodiment, the first barrier structure 140 and the second barrier structure 150 may have a similar construction, but the present disclosure is not limited thereto. In the embodiment, the second barrier structure 150 may include a third conductive layer 152 and a second barrier layer 154, for example, wherein the third conductive layer 152 is located between the second barrier layer 154 and the first substrate 110.

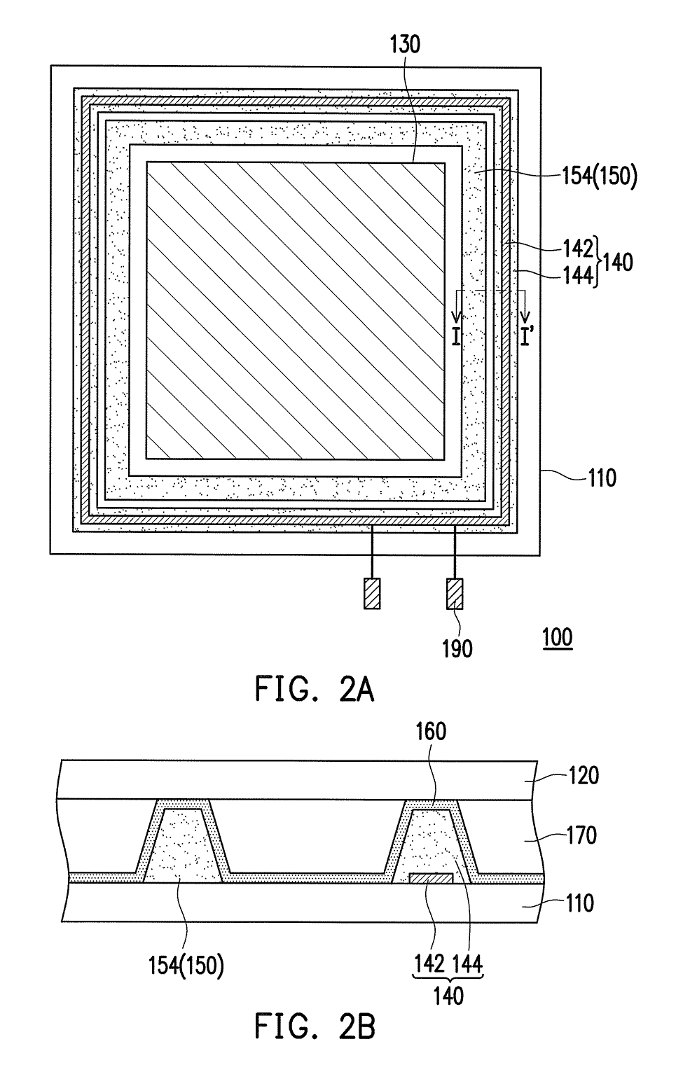

A material of the third conductive layer 152 may include a metal material or other suitable material, and the metal material such as Cu, Ag, Al, Mo, Ti, Ni, W, Zn, Cr, Ta, Sn, Fe, Pt, Ru, Pd, Re, Rh, Au, or any combination thereof, but the present disclosure is not limited thereto. Forming the third conductive layer 152 on the first substrate 110 may be by such as etching, photolithography, printing, or the like. Generally, a material of the second barrier layer 154 may include an inorganic material or an organic-inorganic hybrid material. Forming the second barrier layer 154 on the first substrate 110 may be by etching, printing, photolithography, or the like, and the second barrier layer 154 may cover the third conductive layer 152. In the embodiment, forming the first barrier structure 140 and the second barrier structure 150 is simultaneous, that is, forming the first conductive layer 142 and the third conductive layer 152 may be through the same process steps. Further, in the embodiment, the gas barrier layer 160 covers the first barrier structure 140 and the second barrier structure 150, for example, but the present disclosure is not limited thereto. In an embodiment, when the first barrier structure 140 and the second barrier structure 150 are formed on different substrates, and this may make the gas barrier layer to cover the first barrier structure 140 and the gas barrier layer to cover the second barrier structure 150, respectively. In the embodiment, the first conductive layer 142 and the third conductive layer 152 electrically connect to a pad 190, wherein the pad 190 is grounded. In the present embodiment, the second barrier structure 150 includes a third conductive layer 152 and is capable of shielding external signals. In other embodiments, such as shown in FIG. 2A and FIG. 2B, the second barrier structure 150 may have no the third conductive layer 152, but may include a second barrier layer 154 having barrier and insulation properties.

As shown in the embodiment of FIG. 1A, the first barrier structure 140 and the second barrier structure 150 may have continuous and closed annular structures. In other embodiments, the first barrier structure 140 and the second barrier structure 150 may be continuous or discontinuous structures. For instance, the orthogonal projections of the first barrier structure 140 and the second barrier structure 150 respectively on the first substrate 110 and the second substrate 120 may be a U-shaped pattern, a L-shaped pattern, a dotted pattern, or other patterns that may partially surround the electrical element 130, the present disclosure is not limited thereto. That is, the first barrier structure 140 and the second barrier structure 150 may include a plurality of sections separated from each other, respectively, and these sections may surround the electrical element 130.

In one embodiment, an absorbent layer (not shown) may further be disposed on the first substrate 110 and/or the second substrate 120 and located between the first substrate 110 and the second substrate 120, wherein the absorbent layer may have continuous and closed annular structures to surround the electrical element 130. In other embodiments, the absorbent layer may be continuous or discontinuous structures to surround the electrical element 130. For instance, orthogonal projections of the absorbent layer on the first substrate 110 and/or the second substrate 120 may be a U-shaped pattern, an L-shaped pattern, a dotted pattern, or other patterns that may partially surround the electrical element 130. In addition, a shape of a cross-section of the absorbent layer perpendicular to the first substrate 110 may be, for instance, a rectangular shape, a circular shape, or an elliptical shape, the present disclosure is not limited thereto. The absorbent layer may be located between the first barrier structure 140 and the second barrier structure 150 that are adjacent to each other, or between two adjacent second barrier structures 150. Generally, the absorbent layer may include alkaline-earth oxide, for example, that is able to absorb moisture from the external environment to enhance the barrier ability of the electrical device 100.

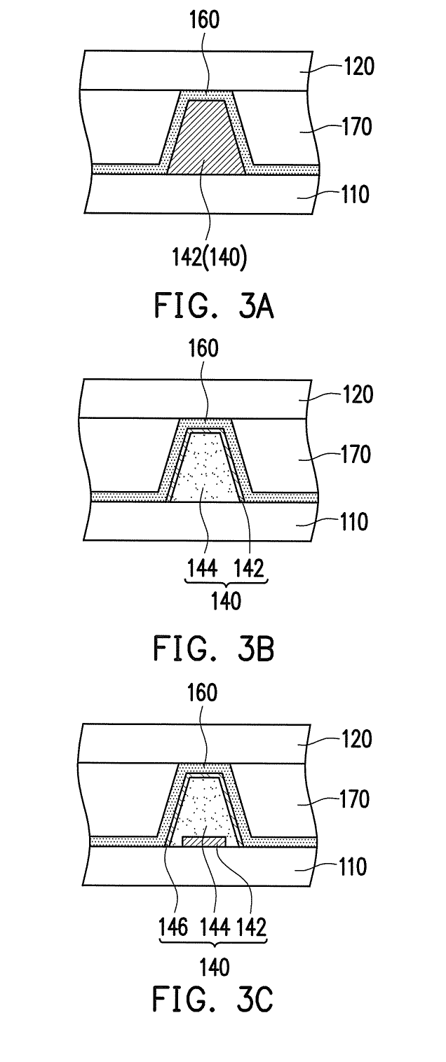

FIG. 3A to FIG. 3C are partial schematic cross-sectional views according to several embodiments of a first barrier structure, respectively. Referring to the embodiment of FIG. 3A, the first barrier structure 140 may include a first conductive layer 142, for example, and the sidewall of the first conductive layer 142 has a protrusion shape. The gas barrier layer 160 may contact and cover the first conductive layer 142. Referring to the embodiment of FIG. 3B, the first barrier structure 140 may include a first conductive layer 142 and a first barrier layer 144, for example, and the first barrier layer 144 is located between the first conductive layer 142 and the first substrate 110. Referring to the embodiment of FIG. 3C, the first barrier structure 140 may include a first conductive layer 142, a first barrier layer 144 and a second conductive layer 146, for example, and the first barrier layer 144 is located between the first conductive layer 142 and the second conductive layer 146. The first conductive layer 142 and the second conductive layer 146 may be made of the same material or different materials. In the embodiment, at least one of the first conductive layer 142 and the second conductive layer 146 electrically connects to the pad 190, for instance, wherein the pad 190 may be grounded.

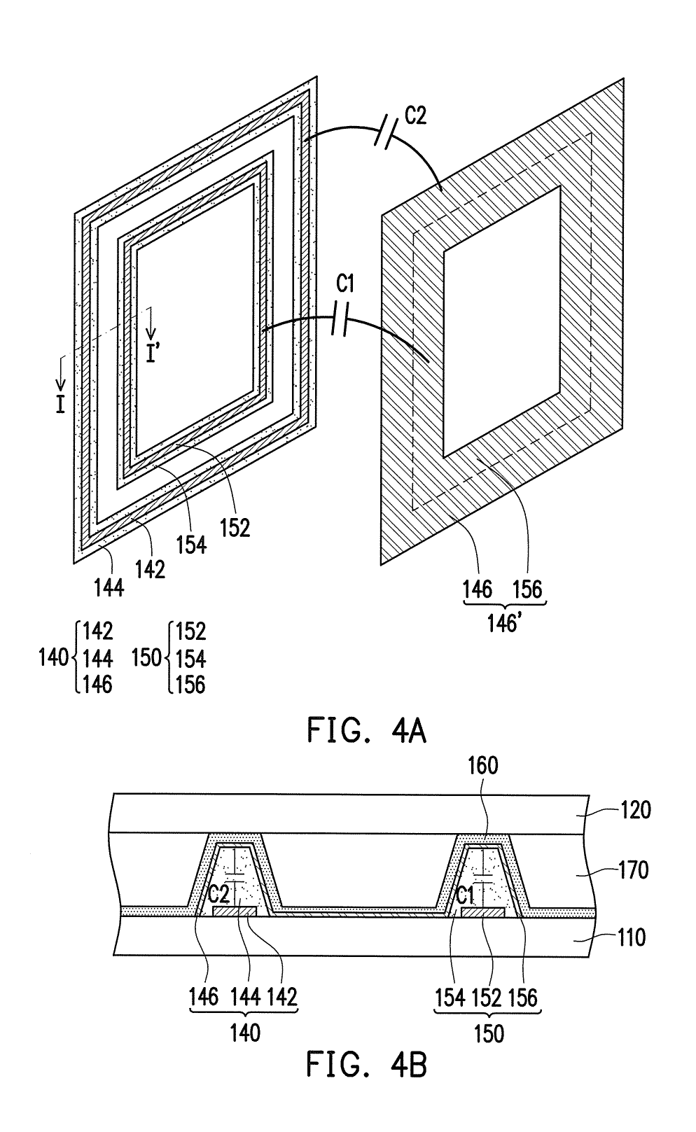

Similarly, the second barrier structure 150 may have the same structure as shown in FIG. 3A to FIG. 3C. For instance, the first barrier structure 140 shown in FIG. 4A and FIG. 4B may have the same structure as shown in FIG. 3C, and relevant explanations will not be provided here. The second barrier structure 150 may have the same structure as shown in FIG. 3C, for example, that is, the second barrier structure 150 may include a third conductive layer 152, a second barrier layer 154, and a fourth conductive layer 156. The second barrier layer 154 is located between the third conductive layer 152 and the fourth conductive layer 156. The third conductive layer 152 and the fourth conductive layer 156 may be made of the same material or different materials. In the embodiment, the first conductive layer 142, the first barrier layer 144 and the second conductive layer 146 may be formed as a capacitor structure having a pressure-sensitive function, the third conductive layer 152, the second barrier layer 154 and the fourth conductive layer 156 may be formed as a capacitor structure having a pressure-sensitive function, for example. In the embodiment, the second conductive layer 146 electrically connects to the fourth conductive layer 156. Moreover, as shown in FIG. 4A, the second conductive layer 146 and the fourth conductive layer 156 may have an integrally formed annular pattern (referred to as a conductive layer 146′), and the conductive layer 146′ may be electrically connected to the pad (not shown), for example. At least one group of the first conductive layer 142 with the third conductive layer 152 and the second conductive layer 146 with the fourth conductive layer 156 may be electrically connected to the pad (not shown), for instance. When a distance between the first conductive layer 142 and the second conductive layer 146 in a vertical direction is changed, the magnitude of the pressure may be determined via the variation of a capacitance C2 between the first conductive layer 142 and the second conductive layer 146. Or the distance between the third conductive layer 152 and the fourth conductive layer 156 in a vertical direction is changed, the magnitude of the pressure may be determined via the variation of a capacitance C1 between the third conductive layer 152 and the fourth conductive layer 156.

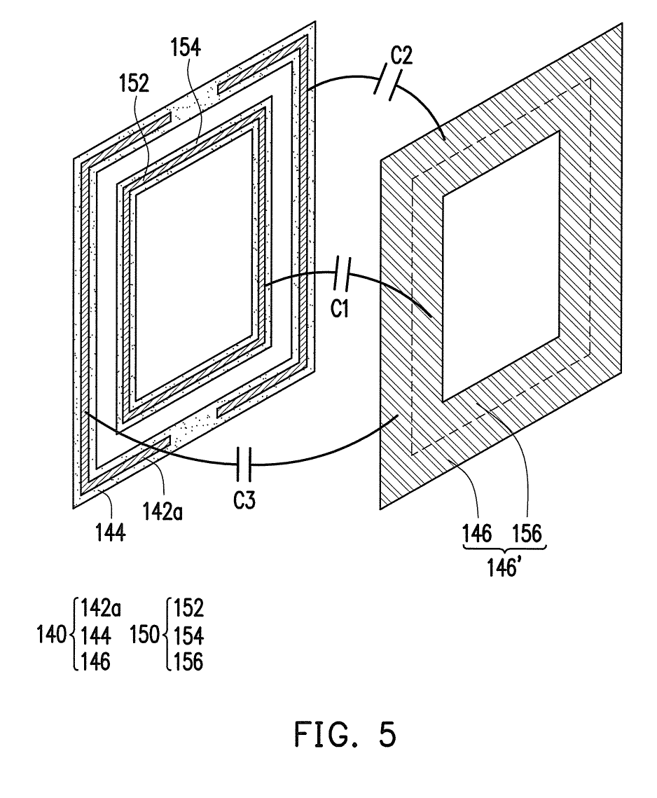

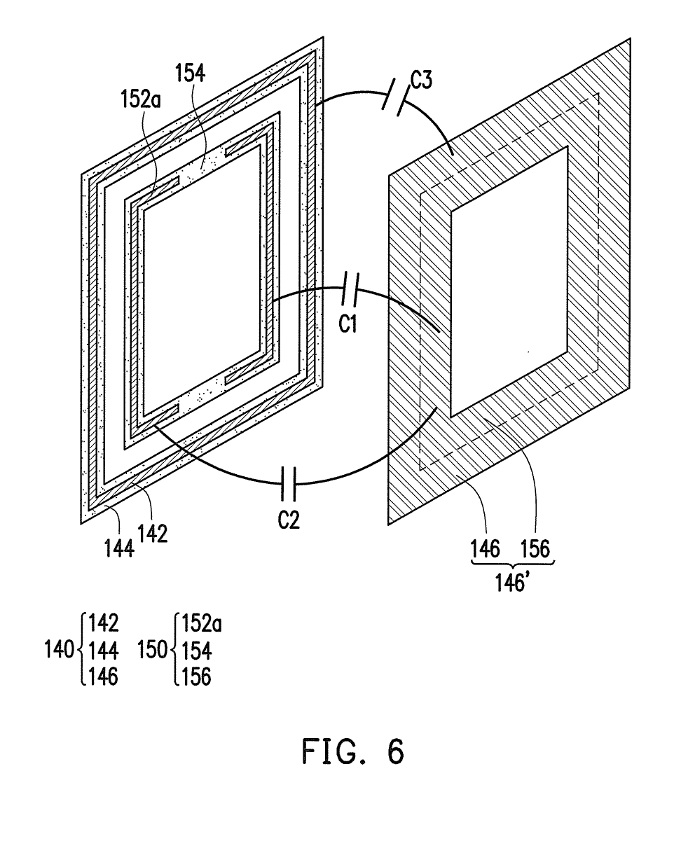

In one embodiment shown in FIG. 5, when the first conductive layer 142 includes a plurality of sub-electrodes 142a separated from each other, the plurality of sub-electrode 142a, the first barrier layer 144 and the second conductive layer 146 are composed of a capacitor structure having a pressure-sensitive function. Thus, the capacitor structure may sense the magnitude of the pressures in different regions, independently. In which the first conductive layer 142 may be a loop electrode, the conductive layer 146′ may also be a loop electrode. In the embodiment, at least one of the first conductive layer 142, the conductive layer 146′ and the third conductive layer 152 may be a loop electrode. Similarly, in an embodiment shown in FIG. 6, the third conductive layer 152 may include a plurality of sub-electrodes 152a separated from each other, the plurality of sub-electrode 152a, the second barrier layer 154 and the fourth conductive layer 156 are composed of a capacitor structure having a pressure-sensitive function. The capacitor structure may sense the magnitude of the pressures in different regions, independently.

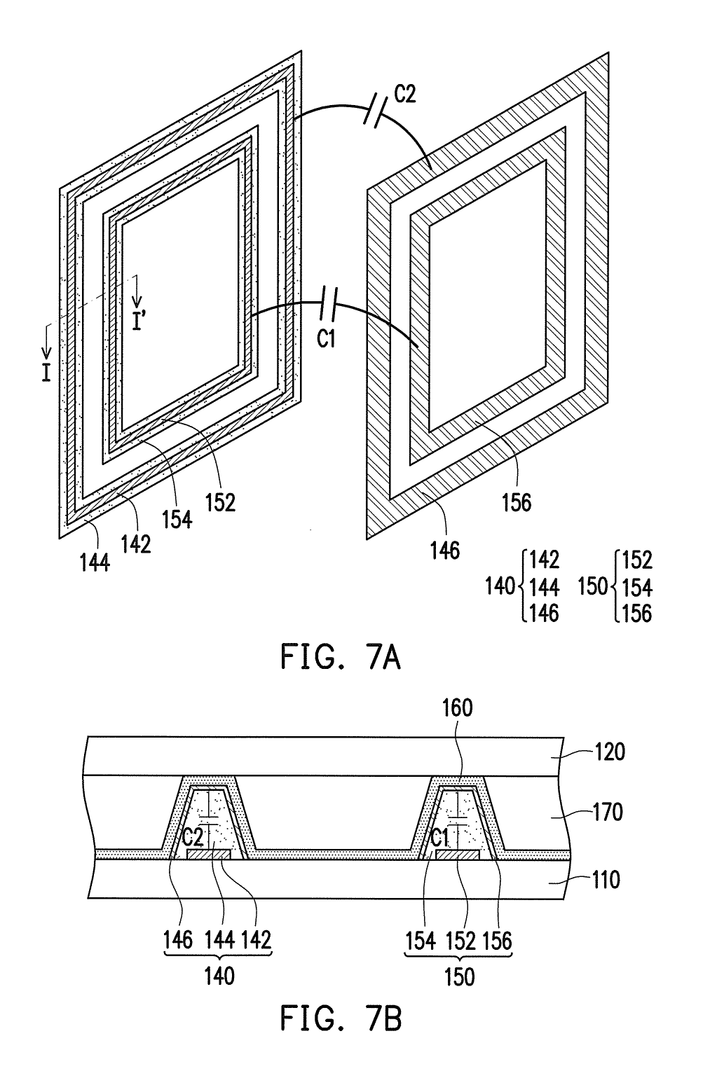

In the foregoing embodiment, the second conductive layer 146 and the fourth conductive layer 156 integrally form as the conductive layer 146′, but the present disclosure is not limited thereto. In one embodiment shown in FIG. 7A and FIG. 7B, the second conductive layer 146 and the fourth conductive layer 156 may be separated from each other, that is, the conductor layers may be discontinuously distributed. In the embodiment, the second conductive layer 146 and the fourth conductive layer 156 may be connected to the pads (not shown) optionally.

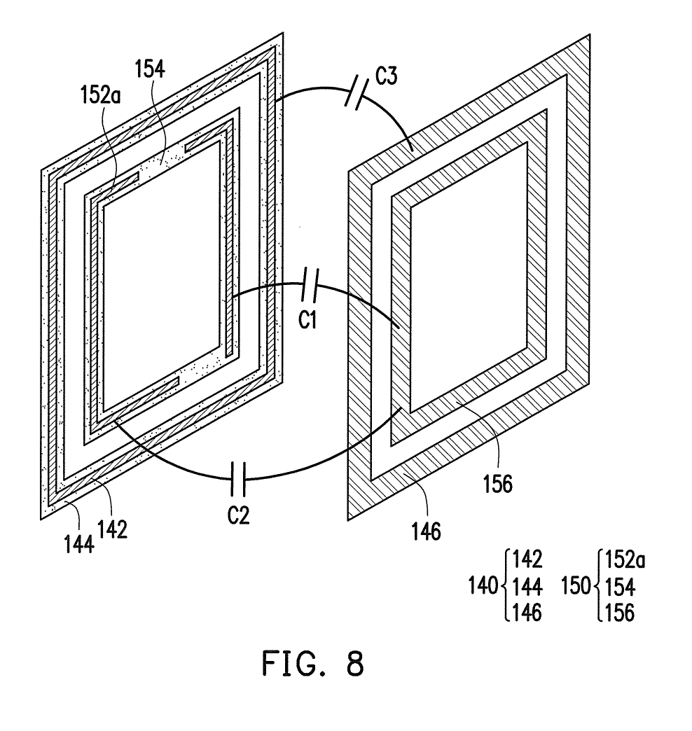

In one embodiment shown in FIG. 8, the third conductive layer 152, for example, includes a plurality of sub-electrodes 152a separated from each other, the plurality of sub-electrode 152a, the second barrier layer 154 and the fourth conductive layer 156 are composed of capacitor structures having a pressure-sensitive function. Thus, the capacitor structures may sense the magnitude of the pressures in different regions, independently. In the embodiment, the first conductive layer 142, the second conductive layer 146 and the fourth conductive layer 156 may be loop electrodes. In the embodiment, the first conductive layer 142 and the second conductive layer 146 form a capacitor C3. A portion of the third conductive layer 152 (that is, the sub-electrode 152a) and the fourth conductive layer 156 form a capacitor C1. Also, another portion of the third conductive layer 152 (that is, another sub-electrode 152a) and the fourth conductive layer 156 form a capacitor C2. In an embodiment, the first conductive layer 142, the second conductive layer 146, the third conductive layer 152 and the fourth conductive layer 156 may be loop electrodes, respectively, or include a plurality of sub-electrodes to sense in different regions. Furthermore, at least one of the first conductive layer 142, the second conductive layer 146, the third conductive layer 152 and the fourth conductive layer 156 may be a loop electrode.

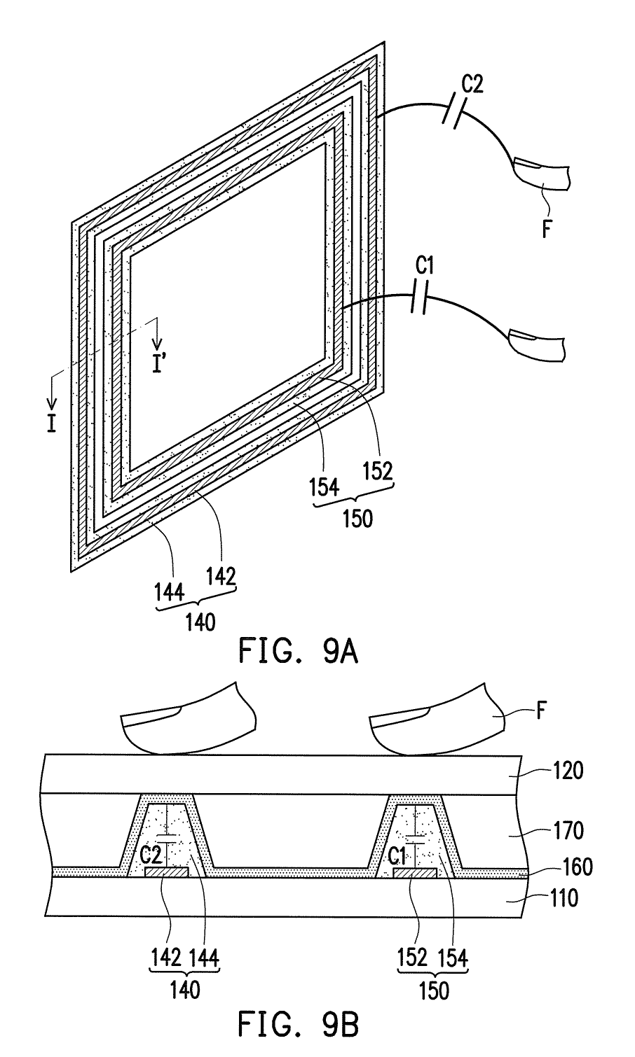

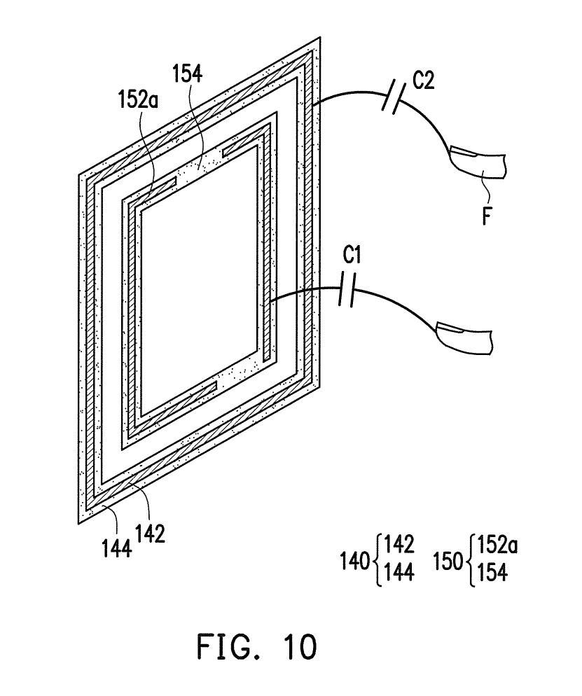

In one embodiment shown in FIG. 9A and FIG. 9B, when the distance between a conductive object F such as fingers and the first conductive layer 142 or between the conductive object F and the third conductive layer 152, is changed, a value of the capacitor C1 or C2 may be changed. Therefore, the magnitude of the pressure may be determined through the variation of a capacitance. In an embodiment shown in FIG. 10, the third conductive layer 152 includes a plurality of sub-electrodes 152a to sense the magnitude of the pressures in different regions.

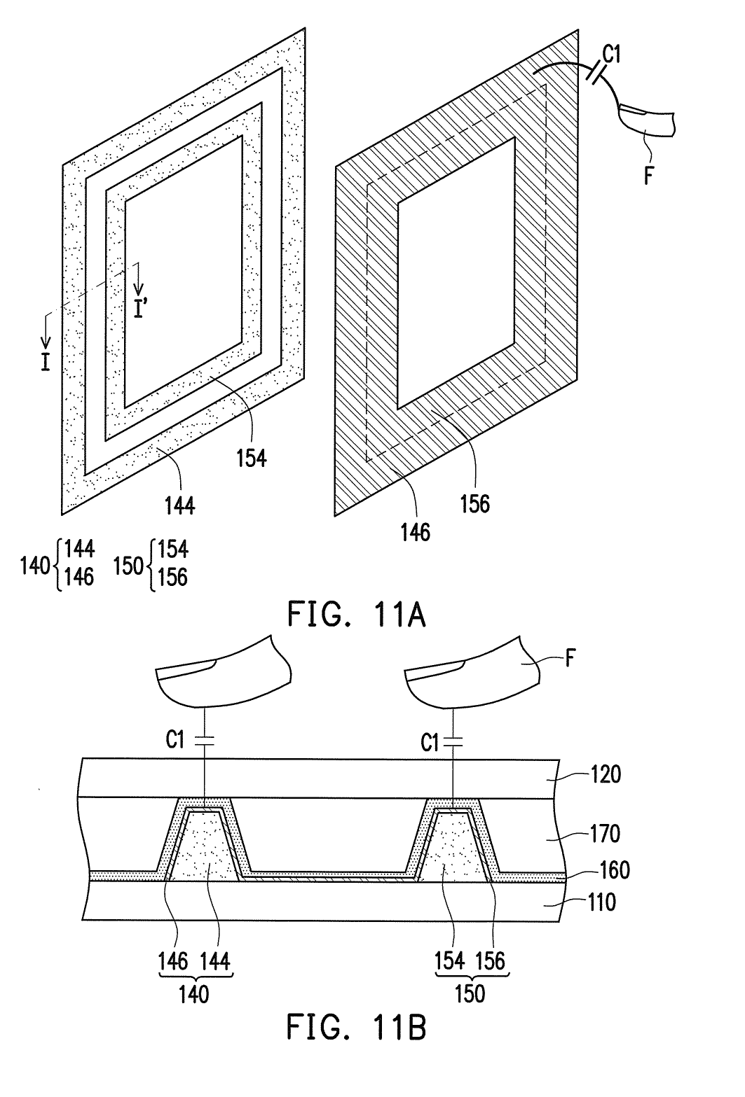

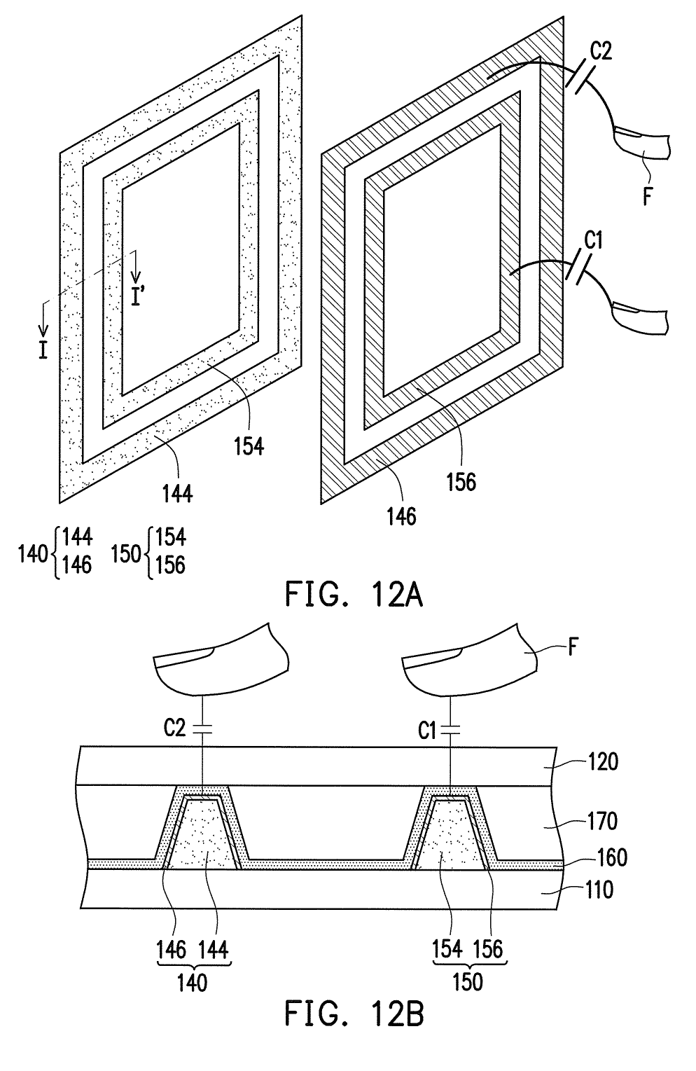

In one embodiment shown in FIG. 11A and FIG. 11B, the second conductive layer 146 is electrically connected to the fourth conductive layer 156. When the distance between the conductive object F and the first conductive layer 142 or between the conductive object F and the third conductive layer 152 is changed, a value of the capacitor C1 may be changed. The magnitude of the pressure may be determined through the variation of a capacitance. In an embodiment shown in FIG. 12A and FIG. 12B, the second conductive layer 146 and the fourth conductive layer 156 are electrically isolated. When the distance between the conductive object F and the first conductive layer 142 or between the conductive object F and the third conductive layer 152 is changed, a value of the capacitor C1 or C2 may be changed. Therefore, the magnitude of the pressure may be determined through the variation of a capacitance.

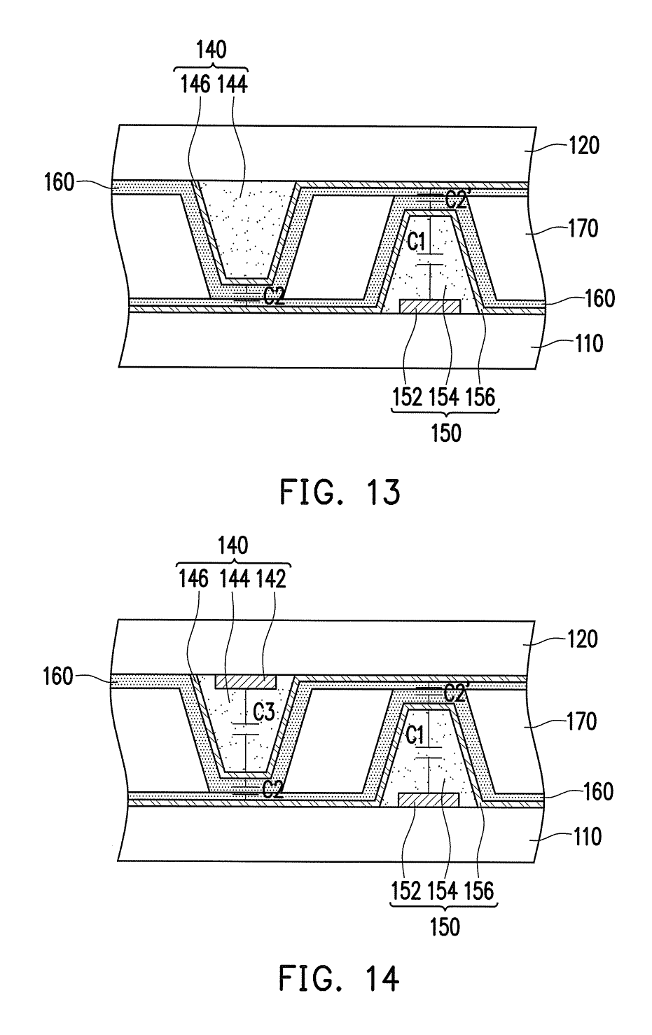

In one embodiment shown in FIG. 13A, the first barrier structure 140 and the second barrier structure 150 may be disposed on different substrates, such as the first barrier structure 140 may be disposed on the second substrate 120, while the second barrier structure 150 may be disposed on the first substrate 110. The third conductive layer 152 and the fourth conductive layer 156 of the second barrier structure 150, for example, may form a capacitor C1. The second conductive layer 146 of the first barrier structure 140 and the fourth conductive layer 156 of the second barrier structure 150 may form a capacitor C2 and C2′. When the distance between the third conductive layer 152 and the fourth conductive layer 156 is changed in a vertical direction, the magnitude of the pressure may be determined through the variation of the capacitance C1 between the third conductive layer 152 and the fourth conductive layer 156. When the distance between the first conductive layer 142 and the fourth conductive layer 156 is changed in a vertical direction, the magnitude of the pressure may be determined through the variation of the capacitances C2, C2′ between the third conductive layer 142 and the fourth conductive layer 156.

In one embodiment shown in FIG. 14, the first barrier structure 140 and the second barrier structure 150 may be disposed on different substrates, such as the first barrier structure 140 may be disposed on the second substrate 120, the second barrier structure 150 may be disposed on the first substrate 110. The third conductive layer 152 and the fourth conductive layer 156 of the second barrier structure 150, for example, may form the capacitor C1. The second conductive layer 146 of the first barrier structure 140 may form the capacitor C2, the fourth conductive layer 156 of the second barrier structure 150 may form the capacitor C2′, and the first conductive layer 142 and the second conductive layer 146 of the first barrier structure 140 may form a capacitor C3. When the distance between the third conductive layer 152 and the fourth conductive layer 156 is changed in the vertical direction, the magnitude of the pressure may be determined through the variation of the capacitance C1. When the distance between the second conductive layer 146 and the fourth conductive layer 156 is changed in the vertical direction, the magnitude of the pressure may be determined through the variation of the capacitances C2, C2′. When the distance between the first conductive layer 142 and the second conductive layer 146 is changed in the vertical direction, the magnitude of the pressure may be determined through the variation of the capacitance C3.

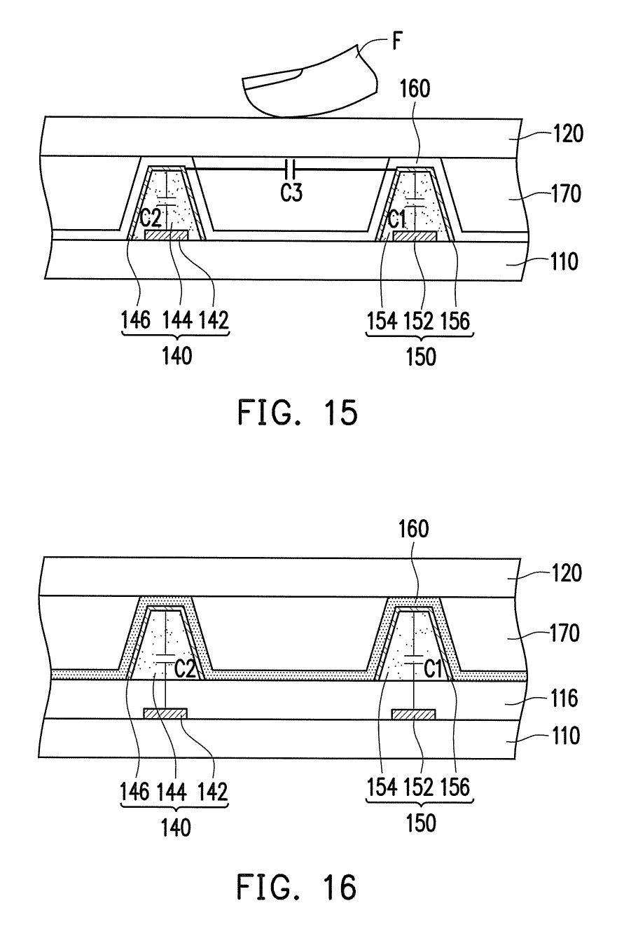

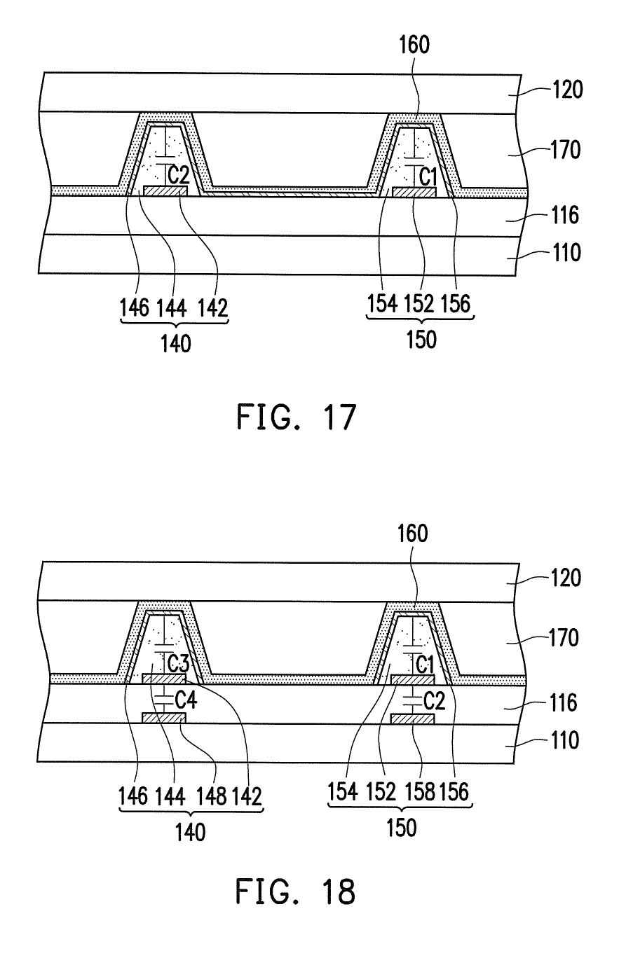

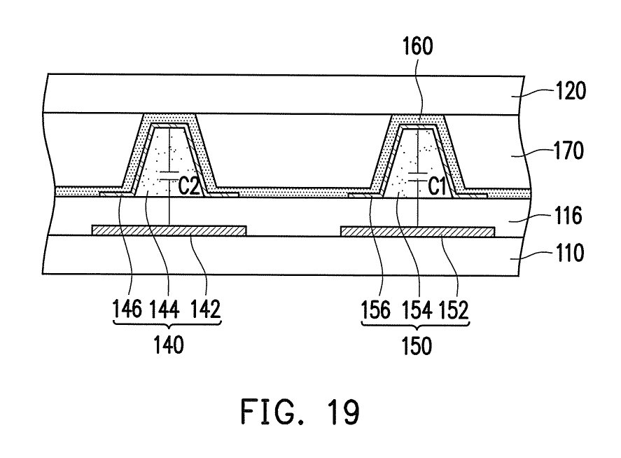

In one embodiment shown in FIG. 15, the second barrier structure 150 has a capacitance C1, the first barrier structure 140 has a capacitance C2, the conductive object F, the first barrier structure 140 and the second barrier structure 150 may form a capacitor C3. When the distance between the first conductive layer 142 and the second conductive layer 146 of the first barrier structure 140 or between the third conductive layer 152 and the fourth conductive layer 156 of the second barrier structure 150 is changed, the capacitance C1 or the capacitance C2 may be changed. When the conductive object F adjacent to the first barrier structure 140 or the second barrier structure 150, a value of the capacitor C3 may be changed. In one embodiment shown in FIG. 16, an insulation layer 116 may be included between the first substrate 110 and the first barrier structure 140, for example, the first conductive layer 142 may be located on the first substrate 110 and between the insulation layer 116 and the first substrate 110. The third conductive layer 152 may be, for example, located on the first substrate 110 and between the insulation layer 116 and the first substrate 110. The second barrier structure 150 has the capacitance C1, while the first barrier structure 140 has the capacitance C2. When the distance between the first conductive layer 142 and the second conductive layer 146 of the first barrier structure 140 or between the third conductive layer 152 and the fourth conductive layer 156 of the second barrier structure 150 is changed, the capacitance C1 or the capacitance C2 may be changed. In an embodiment shown in FIG. 17, the first conductive layer 142 may be located on the insulation layer 116, for example, the insulation layer 116 may be located between the first conductive layer 142 and the first substrate 110. The third conductive layer 152 may be located on the insulation layer 116, for example. The insulation layer 116 may be located between the third conductive layer 152 and the first substrate 110. The second barrier structure 150 has the capacitance C1, while the first barrier structure 140 has the capacitance C2. When the distance between the first conductive layer 142 and the second conductive layer 146 of the first barrier structure 140 or between the third conductive layer 152 and the fourth conductive layer 156 of the second barrier structure 150 is changed, the capacitance C1 or the capacitance C2 may be changed. In an embodiment shown in FIG. 18, the first barrier structure 140 and the second barrier structure 150 may further include conductive layers 148, 158, respectively. The first conductive layer 142 and the conductive layer 148 are located on the first substrate 110, and the third conductive layer 152 and the conductive layer 158 are located on the insulation layer 116. The conductive layer 148, 158 and the first conductive layer 142 may be made of the same material or different materials. The second barrier structure 150 has the capacitances C1, C2. The first barrier structure 140 has the capacitances C3, C4. When the distance between the first conductive layer 142 and the second conductive layer 146 of the first barrier structure 140 or between the third conductive layer 152 and the fourth conductive layer 156 of the second barrier structure 150 is changed, the capacitance C1 or the capacitance C3 may be changed. When the distance between the first conductive layer 142 and the conductive layer 148 of the first barrier structure 140 or between the third conductive layer 152 and the conductive layer 158 of the second barrier structure 150 is changed, the capacitance C2 or the capacitance C4 may be changed.

In one embodiment shown in FIG. 19, an orthogonal projection area of the first conductive layer 142 of the first barrier structure 140 on the first substrate may be larger than that of the first barrier layer 144 of the first barrier structure 140 on the first substrate, which increases a pressure sensing area of the first barrier structure 140. The second barrier structure 150 has the capacitance C1, while the first barrier structure 140 has the capacitance C2. When the distance between the first conductive layer 142 and the second conductive layer 146 of the first barrier structure 140 or between the third conductive layer 152 and the fourth conductive layer 156 of the second barrier structure 150 is changed, the capacitance C1 or the capacitance C2 may be changed.

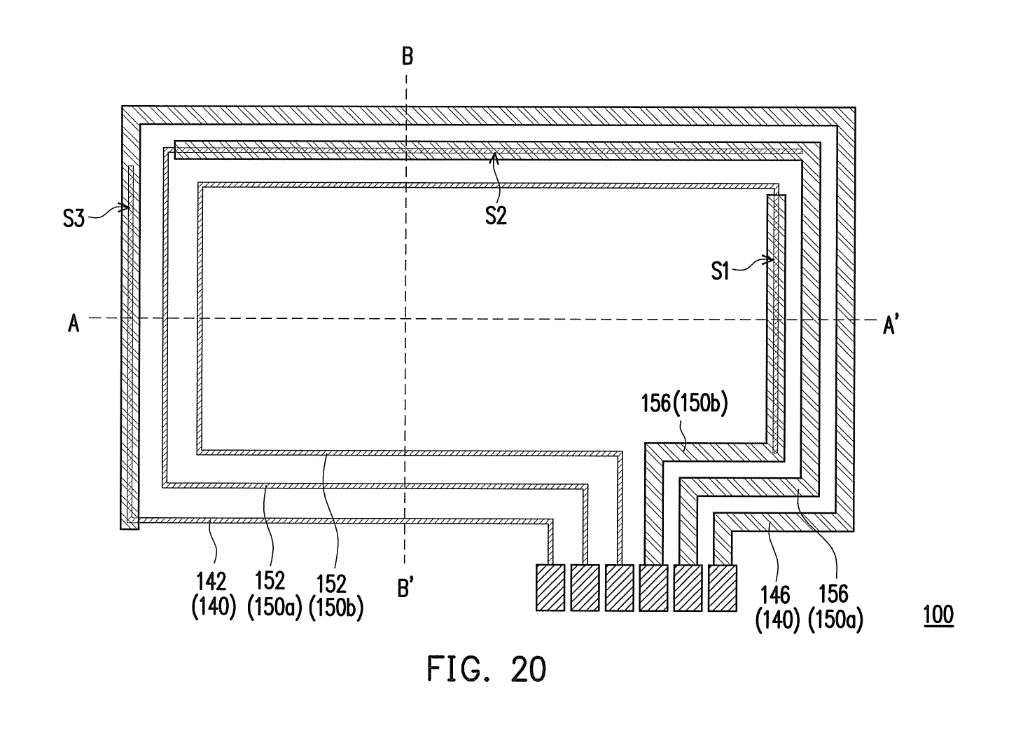

In one embodiment shown in FIG. 20, the first conductive layer 142 and the second conductive layer 146 of the first barrier structure 140 may have different ways of being distributed. The third conductive layer 152 and the fourth conductive layer 156 of the second barrier structure 150a, 150b may have different ways of being distributed. The electrical device 100 is foldable to generate the pressure, the direction and the strength of folding may be determined through the generated pressure, as shown in Table 1. In addition, adding the number of the second barrier structures 150a, 150b may correspond to increase the sensing area, thereby improving the resolution.

TABLE 1

Folded Location

| | |
|---|---|
| A-A′ | B-B′ |

| | |
|---|---|
| Sensing Position | Capacitance Variability |

| | | |
|---|---|---|
| S1 | increase | no change |
| S2 | no change | increase |
| S3 | increase | no change |

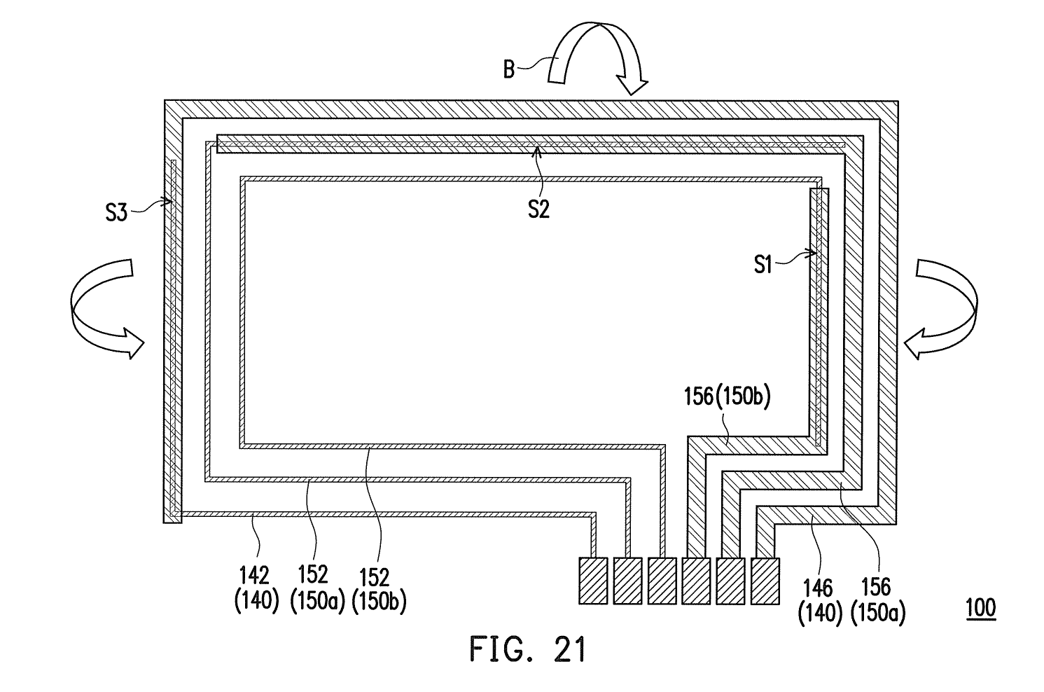

Referring to FIG. 20, in an embodiment that the electrical device 100 is a foldable touch display device, after spreading out the electrical device 100, two fingers may be used to press the positions S1, S2 to wake up the screen, it may replace the wake-up mode by pressing a stating key. Referring to FIG. 21, in an embodiment that the electrical device 100 bends at a single side B, a capacitance of the sensing positions S1, S2, S3 may generate a corresponding amount of pressure, it may determine the direction and the strength of bending.

In one embodiment, the first barrier structure 140 may include at least one conductive layer (for example, the first conductive layer 142, the second conductive layer 146), such that the first barrier structure 140 may have the capability to shield signals to prevent the electrical element 130 surrounded by the first barrier structure 140 from being interfered by external signals. This may enhance the sensing capability or the electrical function of the electrical element 130. In other words, the first barrier structure 140 may protrude from the first substrate 110, and the gas barrier layer 160 may block the invasion of moisture and oxygen to the elements, and prevent the electrical element 130 surrounded by the first barrier structure 140 from being interfered by external signals. The electrical device 100 may have better characteristics. Moreover, the first barrier structure 140 and the second barrier structure 150 form a capacitor structure having a pressure-sensitive function to sense the amount of pressures in different regions, and detect the deformation or the input instruction of the electrical device 100.

In an embodiment of the present disclosure, the total resistance of the first barrier structure may be less than 10KΩ. In another embodiment of the present disclosure, the first barrier structure may have the capability to shield external signals, such that signal to noise ratio is greater than 1.5:1, to prevent the electrical element surrounded by the first barrier structure from being interfered by external signals. This will enhance the sensing capability or the electrical function of the electrical element. In addition, the configuration of the first barrier facilitates the gas barrier layer covering the first barrier structure to block the invasion of moisture or oxygen intrusion inside the elements. In addition, the provided barrier structure and the gas barrier layer achieve shielding signals and barrier effects, the electrical device may have better characteristics. Moreover, the first barrier structure and the second barrier structure form a capacitor structure having a pressure-sensitive function to sense the amount of pressures in different regions, and detect the direction and the strength of bending or the input instruction of the electrical device, such that the electrical device may have the pressure sensing capability.

It will be clear that various modifications and variations may be made to the disclosed methods and materials. It is intended that the specification and examples be considered as exemplary only, with a true scope of the disclosure being indicated by the following claims and their equivalents.

What is claimed is:

1. An electrical device, comprising:
a substrate comprising an active region and a periphery region surrounding the active region;
an electrical element disposed in the active region;
a first barrier structure disposed in the periphery region and surrounding the electrical element, wherein the first barrier structure comprises a first conductive layer; and
a gas barrier layer covering the electrical element and the first barrier structure.

2. The electrical device according to claim 1, wherein a resistance of the first conductive layer is less than 10KΩ.

3. The electrical device according to claim 1, wherein the first barrier structure comprises a first barrier layer, the first conductive layer is located between the first barrier layer and the substrate.

4. The electrical device according to claim 1, wherein the first barrier structure comprises a first barrier layer, the first barrier layer is located between the first conductive layer and the substrate.

5. The electrical device according to claim 1, wherein the first barrier structure comprises a first barrier layer and a second conductive layer, the first barrier layer is located between the first conductive layer and the second conductive layer.

6. The electrical device according to claim 5, wherein the first conductive layer, the first barrier layer and the second conductive layer form a capacitor structure having a pressure-sensitive function.

7. The electrical device according to claim 1, further comprising at least one second barrier structure, wherein the at least one second barrier structure is located in the periphery region and between the electrical element and the first barrier structure.

8. The electrical device according to claim 7, wherein the first barrier structure is electrically connected to the at least one second barrier structure.

9. The electrical device according to claim 7, wherein the first barrier structure is electrically isolated from the at least one second barrier structure.

10. The electrical device according to claim 7, wherein a total resistance of the second barrier structure is different from that of the first barrier structure.

11. The electrical device according to claim 7, wherein the at least one second barrier structure comprises a third conductive layer.

12. The electrical device according to claim 7, wherein the at least one second barrier structure comprises a third conductive layer and a second barrier layer, and the second barrier layer is located between the third conductive layer and the substrate.

13. The electrical device according to claim 12, wherein the first barrier structure comprises a first barrier layer, the first barrier layer is located between the first conductive layer and the substrate, and the first conductive layer electrically connects to the third conductive layer.

14. The electrical device according to claim 12, wherein the second barrier structure comprises a fourth conductive layer, the second barrier layer is located between the third conductive layer and the fourth conductive layer.

15. The electrical device according to claim 14, wherein the third conductive layer, the second barrier layer and the fourth conductive layer form a capacitor structure having a pressure-sensitive function.

16. The electrical device according to claim 14, wherein the first barrier structure comprises a first barrier layer and a second conductive layer, the first barrier layer is located between the first conductive layer and the second conductive layer, the second conductive layer is located between the gas barrier layer and the first barrier layer, the fourth conductive layer is located between the gas barrier layer and the second barrier layer, and the second conductive layer electrically connects to the fourth conductive layer.

17. The electrical device according to claim 14, wherein at least one of the first conductive layer, the second conductive layer, the third conductive layer and the fourth conductive layer have a plurality of electrodes separated from each other.

18. The electrical device according to claim 7, wherein one of the first barrier structure and the second barrier structure is located on the substrate, and the other of the first barrier structure and the second barrier structure is located on another substrate disposed opposite to the substrate.

19. The electrical device according to claim 1, wherein a shielding effect of the first barrier structure is such that a signal to noise ratio is greater than 1.5:1 at one side of the first barrier structure adjacent to the electrical element.

20. The electrical device according to claim 1, wherein a total resistance of the first barrier structure is less than 10KΩ.
